(19) United States
(12) Patent Application Publication
(10) Pub. No.: US 2024/0162966 A1
(43) Pub. Date: May 16, 2024

(54) BEAM SCANNING SYSTEM

(71) Applicant: SHENZHEN HUAYI MEDICAL TECHNOLOGIES CO., LTD, Shenzhen (CN)

(72) Inventors: Yi HUANG, Shenzhen (CN); Yan GONG, Shenzhen (CN); Chaijie DUAN, Shenzhen (CN); Wei HU, Shenzhen (CN); Huajie LIN, Shenzhen (CN)

(73) Assignee: SHENZHEN HUAYI MEDICAL TECHNOLOGIES CO., LTD, Shenzhen (CN)

(21) Appl. No.: 18/203,605

(22) Filed: May 30, 2023

Related U.S. Application Data
(63) Continuation of application No. PCT/CN2022/131135, filed on Nov. 10, 2022.

(51) Int. Cl. H04B 7/06

(52) U.S. Cl. CPC H04B 7/06952

(57) ABSTRACT

A beam scanning system is provided, including an antenna module and a signal processing circuit. The antenna module includes N transmitting antennas arranged along a first direction on the first plane. Each transmitting antenna extends in a second direction on the first plane and is configured to convert electrical signals into millimeter wave electromagnetic signals. N millimeter wave electromagnetic signals sent by the N transmitting antennas form a target beam. The signal processing circuit is connected with the antenna module to control the target beam to perform two-dimensional scanning by outputting a frequency and phase controllable electrical signal to each of the N transmitting antennas. The frequency and phase of the electrical signals output to the N transmitting antennas may be adjusted by the signal processing circuit when the multiple transmitting antennas in the antenna module are only arranged in one direction.

### RELATED APPLICATION

This application is a continuation of PCT/CN2022/131135, filed on Nov. 10, 2022, and the contents of the foregoing document are incorporated herein by reference in their entirety.

### TECHNICAL FIELD

The present disclosure relates to relates to the field of wireless technology, and in particular to a beam scanning system.

### BACKGROUND

With the development of 5G technology, beamforming technology has been widely used. Based on the beamforming technology, an antenna module may perform beam scanning in a specified direction (or direction range). Some application scenarios (such as autonomous driving, medical imaging, etc.) require the antenna module an electronic device (such as radar) to have beam scanning capability in two-dimensional space, so that the electronic device can generate images with higher resolution.

In the related art, in order to realize beam scanning in two-dimensional space, multiple antennas need to be arranged in at least two dimensions respectively. For example, a beam scanning system may arrange multiple antennas along a first direction, so as to perform beam scanning of one spatial dimension by these antennas; the beam scanning system may also arrange multiple antennas along a second direction, so as to perform beam scanning in another spatial dimension by these antennas. It can be seen that the above-mentioned technologies need to arrange a large number of antennas in the beam scanning system. Correspondingly, it is also necessary to set up a separate transmit/receive channel (such as low-noise amplifiers, mixers, IF filters, and analog-to-digital converters/digital-to-analog converters, etc.) for each antenna in order to process the signal. It should be understood that when the number of antennas is large, the number of channels is also large, resulting in a significant increase in the cost of the beam scanning system.

### BRIEF SUMMARY

The present disclosure provides a beam scanning system, which may perform beam scanning in two-dimensional space at a low cost.

In a first aspect, the present disclosure provides a beam scanning system, including: an antenna module, including N transmitting antennas arranged in a first direction on a first plane, wherein N is an integer greater than 1, each of the N transmit antennas extends in a second direction on the first plane and is configured to convert an electrical signal into a millimeter wave electromagnetic signal, and N millimeter wave electromagnetic signals sent by the N transmitting antennas form a target beam; and a signal processing circuit connected with the antenna module, wherein during operation, the signal processing circuit controls the target beam to perform two-dimensional scanning by outputting one electrical signal with controllable frequency and phase to each of the N transmitting antennas respectively.

In view of the above technical solutions, it can be seen that the beam scanning system provided by the present disclosure includes an antenna module and a signal processing circuit, where the antenna module includes N transmitting antennas arranged along a first direction on a first plane, and N is an integer greater than 1. Each transmitting antenna extends along a second direction on the first plane and is configured to convert an electrical signal into a millimeter wave electromagnetic signal. N millimeter wave electromagnetic signals sent by the N transmitting antennas may form a target beam. The signal processing circuit is connected with the antenna module. In operation, the target beam is controlled to perform two-dimensional scanning by outputting a frequency and phase controllable electrical signal for each of the N transmitting antennas respectively. Thus, it may be seen that the solutions of the present disclosure may adjust the frequency and phase of the electrical signal output to each of the N transmitting antennas via the signal processing circuit in the case where the multiple transmitting antennas in the antenna module are arranged only along one direction (the first direction), such that two-dimensional scanning of the target beam may be achieved. Compared with related technologies that require multiple transmitting antennas to be arranged in multiple directions, the present disclosure reduces the number of transmitting antennas in the antenna module. Correspondingly, the number of channels working with the transmitting antennas may also be reduced, thereby reducing the cost. That is to say, the beam scanning system provided by the present disclosure may achieve the two-dimensional scanning of the target beam at a low cost.

Additional features of the beam scanning system provided the present disclosure will be partially listed in the description below. The technical aspects of the beam scanning system provided by the present disclosure may be fully explained by practice or use of the methods, apparatus and combinations thereof described in the detailed examples below.

### BRIEF DESCRIPTION OF THE DRAWINGS

To describe the technical solutions in some exemplary embodiments of the present disclosure, the accompanying drawings of the exemplary embodiments will be briefly described below. Apparently, the accompanying drawings described below are only some exemplary embodiments of the present disclosure. A person of ordinary skill in the art may further obtain other drawings based on these accompanying drawings without inventive efforts.

FIG. 1 is a schematic diagram of a beam scanning system provided according to some exemplary embodiments of the present disclosure;

FIG. 2 is a schematic diagram of the beam scanning system shown in FIG. 1 performing beam scanning;

FIG. 3 is a front view of a leaky wave antenna provided according to some exemplary embodiments of the present disclosure;

FIG. 4 is a side view of the leaky wave antenna shown in FIG. 3;

FIG. 5 is an enlarged view of the part A shown in FIG. 3;

FIG. 6 is a rear view of the leaky wave antenna shown in FIG. 3;

FIG. 7 is a radiation pattern of the beam scanning system on a yOz plane according to some exemplary embodiments of the present disclosure; and

FIG. 8 is a radiation pattern of the beam scanning system on a xOz plane according to some exemplary embodiments of the present disclosure.

### DETAILED DESCRIPTION

The following description provides certain specific application scenarios and requirements of the present disclosure, with the purpose of enabling a person skilled in the art to manufacture and use the contents of the present disclosure. Various modifications to the disclosed exemplary embodiments may become apparent to a person skilled in the art. In addition, the general principles defined herein may be applied to other embodiments and applications without departing from the spirit and scope of the present disclosure. Accordingly, the description is not limited to the exemplary embodiments shown, but is to be accorded the widest scope consistent with the claims.

The terminology used herein is for the purpose of describing particular exemplary embodiments only and is not intended to be limiting. For example, as used herein, the singular forms “a”, “an” and “the” may also include the plural forms unless the context explicitly dictates otherwise. When used in the present disclosure, the terms “comprising”, “including” and/or “containing” mean that the associated features, integers, steps, operations, elements and/or components are present. However, this does not exclude the presence of one or more other features, integers, steps, operations, elements, components and/or groups, or other features, integers, steps, operations, elements, components and/or groups may be added in the system/method.

These and other features of the present disclosure, as well as the operation and function of related elements of the structure, and the economy of assembly and manufacture of the components, may be significantly enhanced in view of the following description. Reference may be made to the accompanying drawings, all of which form a part of the present disclosure. It should be understood, however, that the drawings are for purposes of illustration and description only and are not intended to limit the scope of the present disclosure. It should also be understood that the figures are not drawn to scale.

The flowcharts used in the present disclosure illustrate the operation of system implementations according to some exemplary embodiments in the present disclosure. It should be understood that the operations of the flowcharts may be performed in different orders. The operations may be performed in a reverse order or concurrently. Additionally, one or more other operations may be added to, or removed from, the flowcharts.

For the convenience of description, firstly, the terms that appear in the description of the present disclosure will be explained below.

Beamforming, also known as spatial filtering, is a signal processing technology that uses an antenna array to send and receive signals in a directional manner. By adjusting the parameters of the antenna elements in an antenna array, the beamforming technology enables signals at certain angles to obtain constructive interference, while signals at other angles obtain destructive interference, so as to finally form a directional beam. Beamforming may be used at both a signal transmitting end and a signal receiving end.

Antenna pattern, also known as radiation pattern, refers to the graph of the relative field strength (normalized modulus) of a radiation field changing with the direction at a certain distance from an antenna. It is usually represented by two mutually perpendicular plane patterns in the maximum radiation direction of the antenna. The antenna pattern usually has two or more lobes, where a lobe with the greatest radiation intensity is referred to as the main lobe and the remaining lobes are referred to as accessory lobes or side lobes; the side lobe opposite to the main lobe is referred to as the back lobe.

Beam herein refers to the main lobe of an antenna pattern, which is the most concentrated part of the antenna radiation capability. A beam may be in any shape, which determined by the specific beamforming technique used by the antenna.

The direction of a beam refers to the direction to which the beam points, and may also be referred to as the emission direction of the beam, or the scanning direction of the beam. For example, when the beam is in the shape of a lobe, the direction of the beam may specifically refer to the direction in which the central axis of the beam (i.e., the part with the most concentrated energy) points.

Millimeter wave refers to an electromagnetic wave with a wavelength of 1 to 10 millimeters (frequency range of 30 to 300 GHz). Millimeter waves are located in the wavelength range where microwaves and far-infrared waves overlap, so they have the characteristics of both spectra. Compared with infrared waves, the beam of millimeter waves is very narrow, which may more accurately distinguish a target and restore the details of the target. Compared with lasers, millimeter waves are less affected by changes in weather and the external environment (such as rain, snow, dust, sunlight, etc.), and have lower requirements for climate. Compared with those of microwaves, millimeter wave components are smaller in size, and millimeter wave devices are easier to miniaturize.

Leaky wave antenna, when an electromagnetic wave propagates along a traveling wave structure thereof, if radiation is continuously generated along the structure, the radiated wave is referred to a leaky wave. This structure that produces leaky waves is referred to as a leaky wave antenna. The leaky wave antenna is a traveling wave antenna. A traveling wave antenna refers to an antenna in which the fed electromagnetic field exhibits a traveling wave distribution. In addition to inheriting the broadband characteristics of a traveling wave antenna, a leaky wave antenna also has the characteristic of beam scanning with frequency, that is, the direction of the beam changes with frequency. A leaky wave antenna is usually formed by opening periodic slots in a waveguide wall thereof. When a leaky wave antenna is in operation, the electromagnetic wave signal transmitted inside the waveguide continuously leaks out from the periodic slots on the waveguide wall to generate radiation, forming a radiation pattern of beam scanning with high directivity and controllable frequency.

The scan rate of a leaky wave antenna is used to characterize how quickly the scan angle of the beam (main lobe) emitted by the leaky wave antenna changes with frequency. In the present disclosure, the ratio of a change Δθ in the scanning angle of a beam emitted by the leaky wave antenna to a frequency change Δf may be used as the scanning rate of the leaky wave antenna. When the scanning rate of a leaky wave antenna is high, it means that the beam direction of the leaky wave antenna is more sensitive to a frequency change. That is, changing the frequency by a small value may make the beam sweep a large angle. Therefore, the scan rate of a leaky wave antenna may also be referred to as the sensitivity of the leaky wave antenna with respect to frequency changes.

Antenna array, an antenna system formed by two or more single antennas which are fed and arranged in space according to certain requirements, is referred to as an antenna array. The radiation field of an antenna array is the vector sum of the radiation fields of its individual antennas, and its characteristics depend on the form, position, arrangement, and excitation amplitude and phase of the individual antennas.

End-fire direction and side-fire direction, if the maximum radiation direction of an antenna is parallel to the antenna, the maximum radiation direction is referred to as an end-fire direction; if the maximum radiation direction of an antenna is perpendicular to the antenna, the maximum radiation direction is referred to as a side-fire direction.

Before describing some specific exemplary embodiments of the present disclosure, the application scenarios of the present disclosure will be introduced.

Autonomous driving scenario: a millimeter wave radar has the characteristics of short wavelength and small equipment size, and has significant advantages in detection accuracy and detection distance. Therefore, it plays a very important role in an automatic driving scenario. A millimeter wave radar is provided with a transmitting antenna and a receiving antenna. The transmitting antenna is capable of emitting directional millimeter waves. When the millimeter wave encounters an obstacle and is reflected back, the receiving antenna receives the reflected echo. In this way, the radar may determine the position of the obstacle based on factors such as the moment when the transmitting antenna emits millimeter waves, the moment when the receiving antenna receives the echo, and the driving speed of the vehicle. The radar can also determine the speed, azimuth and other information of obstacle based on information such as the frequency and phase of millimeter waves emitted by the transmitting antenna, and the frequency and phase of echoes received by the receiving antenna. It can be seen that a millimeter wave radar may help a vehicle to accurately perceive the surrounding environment, quickly identify the distance, angle, speed and other information between the surrounding obstacles and the vehicle, thereby ensuring the safe driving of the vehicle.

Medical imaging scenario: the principle of millimeter wave imaging is to irradiate a measured object with millimeter waves, and then reconstruct the shape or permittivity distribution of the measured object based on the measured values of the scattered field outside the measured object. Since the dielectric constant is closely related to the water content of biological tissues, millimeter wave imaging is very suitable for imaging biological tissues. Therefore, millimeter wave imaging has been widely used in medical imaging scenarios. In a medical imaging scenario, a medical device transmits millimeter waves by its transmitting antenna, the millimeter waves scan biological surfaces at high speed and are reflected back, and the medical device receives the reflected echo by its receiving antenna. Furthermore, a medical device may reconstruct images of biological tissues based on the echo information, and these images may be used for medical analysis and the like.

It should be noted that the above autonomous driving and medical imaging scenarios are only some of the multiple usage scenarios provided in this description. The beam scanning system provided herein is not only be applied to the autonomous driving and medical imaging scenarios, but also applied to any othewr suitable scenarios for millimeter wave communication, such as millimeter wave-based security inspection scenarios, etc. A person skilled in the art should understand that applications of the beam scanning system described in the present disclosure to other usage scenarios is also within the scope of protection of the present disclosure.

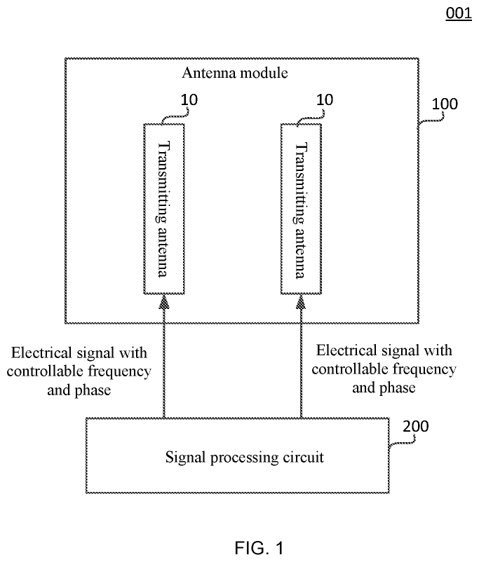

FIG. 1 is a schematic diagram of a beam scanning system provided according to some exemplary embodiments of the present disclosure. A beam scanning system 001 (hereinafter referred to as the system 001) may be applied to any suitable beam scanning scenario, such as a millimeter wave radar in autonomous driving scenarios, a millimeter wave imaging device in medical imaging scenarios, and so on. As shown in FIG. 1, the system 001 may include an antenna module 100 and a signal processing circuit 200.

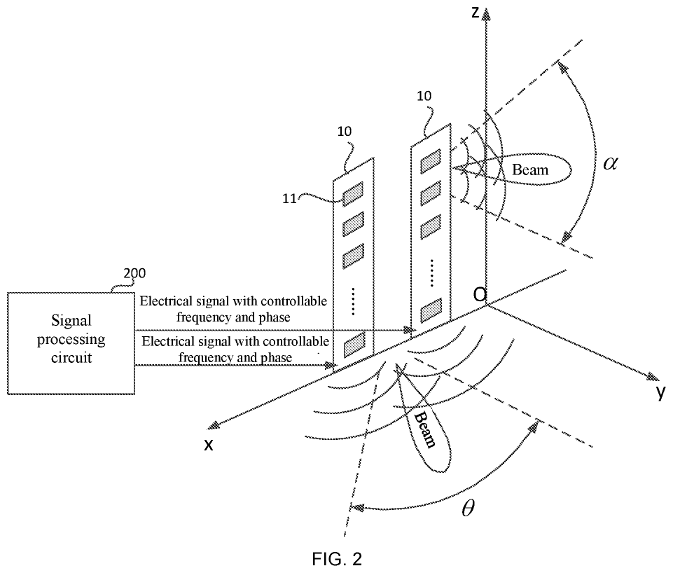

The antenna module 100 may include N transmitting antennas 10 arranged along a first direction on a first plane. N is an integer greater than 1. The first plane may be any plane in free space, and the first direction may be any direction on the first plane. FIG. 2 is a schematic diagram of the beam scanning system shown in FIG. 1 performing beam scanning. As shown in FIG. 2, taking the space Cartesian coordinate system O-xyz as an example, the first plane may be the xOz plane, and the first direction may be the x-axis direction. FIG. 1 and FIG. 2 illustrate the case where two transmitting antennas 10 are arranged along a first direction on a first plane. In some exemplary embodiments, other numbers (e.g., 3, 4, 5, etc.) of transmitting antennas 10 may be arranged along the first direction on the first plane. Each transmit antenna 10 may extend along a second direction within the first plane. The second direction may be any direction on the first plane different from the first direction. In some exemplary embodiments, the second direction may be perpendicular to the first direction. For example, with reference to FIG. 2, the second direction may be the z-axis direction, that is, each transmitting antenna 10 extends along the z-axis direction. The aforementioned N transmitting antennas 10 may be the same type of antenna.

It should be noted that the present disclosure does not limit the shape of the transmitting antenna 10, which may be a rectangle, a parallelogram, a circle, an ellipse, or another shape. With reference to FIG. 2, in the case where the transmitting antenna 10 is rectangular, the first direction may be the short axis direction of the transmitting antenna 10 (i.e., the x-axis direction), and the second direction may be the direction of the long axis of the transmitting antenna 10 (i.e., the z-axis direction). The first direction and the second direction determine the first plane where the antenna module 100 is located.

In some exemplary embodiments, the working frequency band of the antenna module 100 may include 60 GHz to 64 GHz.

As shown in FIG. 1, any two adjacent transmitting antennas 10 in the antenna module 100 may be separated by a certain distance to avoid mutual interference between different transmitting antennas 10. In some exemplary embodiments, assuming that the working wavelength of the antenna module 100 is λ and the distance between any two adjacent transmitting antennas 10 in the antenna module 100 is d1, then the value of d1 may be approximately equal to λ/2, That is to say, the difference between d1 and λ/2 is within a preset range. In this way, on the one hand, the interference between adjacent transmitting antennas 10 may be reduced as much as possible; on the other hand, the distance between adjacent transmitting antennas 10 may also be avoided from being too large. This may facilitate the miniaturization design of the antenna module 100.

Each transmitting antenna 10 is configured to convert an electrical signal into a millimeter wave electromagnetic signal and radiate the millimeter wave electromagnetic signal into free space. In this way, N millimeter wave electromagnetic signals emitted by the N transmitting antennas 10 in the antenna module 100 interfere in free space to form a target beam, where the target beam refers to the main lobe beam in the radiation pattern corresponding to the antenna module 100.

Continuing to refer to FIG. 1, the signal processing circuit 200 is connected with the antenna module 100, and is configured to output an electrical signal with controllable frequency and phase to each of the N transmitting antennas respectively. In some exemplary embodiments, the signal processing circuit 200 may be directly electrically connected to the antenna module 100. For example, each transmitting antenna 10 in the antenna module 100 may be independently connected to the signal processing circuit 200. In some exemplary embodiments, the signal processing circuit 200 may also be electrically connected to the antenna module 100. For example, the signal processing circuit 200 may be connected to a preset intermediate device, and the preset intermediate device is independently connected to each transmitting antenna 10 in the antenna module 100. In some exemplary embodiments, the signal processing circuit 200 may include a signal generator, a phase controller, and a frequency controller. The signal processing circuit 200 may first generate a reference electrical signal by the signal generator, and then process the reference electrical signal by the phase controller and/or the frequency controller to obtain N electrical signals with controllable frequency and phase. Furthermore, the signal processing circuit 200 outputs the above N channels of electrical signals to the N transmitting antennas 10 based on a one-to-one correspondence.

When the signal processing circuit 200 is in operation, it may control a target beam to perform two-dimensional scanning by adjusting the frequency and phase of the N electrical signals output by it, the above-mentioned “two-dimensional scanning by the target beam” herein means that the target beam may scan in two-dimensional space. For example, the direction of the target beam may scan along a second plane and a third plane simultaneously, where the second plane and the third plane are two mutually perpendicular planes in free space.

It should be noted that in the present disclosure, the second plane and the third plane should not be understood as specific planes, but should be understood as a series of planes parallel to each other. That is to say, another expression for “the direction of the target beam scans along the second plane” may be “the direction of the target beam scans in the dimensional space determined by the second plane;” similarly, another expression for “the direction of the target beam scans along the third plane” may be “the direction of the target beam scans in the dimensional space determined by the third plane.”

In some exemplary embodiments, the second plane may be any plane satisfying the following conditions: it is perpendicular to the first plane and parallel to the second direction. It should be understood that when the first direction and the second direction are perpendicular to each other, the second plane is also perpendicular to the first direction. For example, with reference to FIG. 2, the second plane may be the yOz plane or any plane parallel to the yOz plane. In some exemplary embodiments, when the target beam performs two-dimensional scanning, it may scan all directions on the second plane, or scan some directions on the second plane. For example, in FIG. 2, the scanning angle of the target beam on the second plane may be α.

In some exemplary embodiments, the third plane may be any plane satisfying the following conditions: it is perpendicular to the first plane and parallel to the first direction. It should be understood that, in the case where the first direction and the second direction are perpendicular to each other, the third plane is also perpendicular to the second direction. For example, with reference to FIG. 2, the third plane may be the xOy plane or any plane parallel to the xOy plane. In some exemplary embodiments, when the target beam performs two-dimensional scanning, it may scan all directions on the third plane, or may scan some directions on the third plane. For example, in FIG. 2, the scanning angle of the target beam on the third plane may be θ.

In some exemplary embodiments, the signal processing circuit 200 may control the direction of the target beam to scan on the second plane by adjusting the frequency of the N electrical signals to vary within a preset frequency band. In this case, the frequency of the electrical signal output by the signal processing circuit 200 to each transmitting antenna 10 may change within a preset frequency band over time. The signal processing circuit 200 may adjust the frequencies of the N electrical signals synchronously (that is, the frequencies of the N electrical signals output by the signal processing circuit 200 may be the same at the same moment); alternatively, they may be adjusted asynchronously (that is, the frequencies of the N electrical signals output by the signal processing circuit 200 may be different at the same moment). This is not limited in the present disclosure. The preset frequency band mentioned above may be the working frequency band of the antenna module. For example, when the working frequency band of the antenna module is from 60 GHz to 64G Hz, the signal processing circuit 200 may adjust the frequencies of N electrical signals within the frequency range of from 60 GHz to 64G Hz.

Each transmitting antenna 10 in the antenna module 100 may be an antenna having a characteristic of beam scanning with frequency (that is, beam direction changes with frequency). In this way, when the frequency of the electrical signal received by the transmitting antenna 10 changes, the direction of the beam emitted by it may also change accordingly. In some exemplary embodiments, each transmit antenna 10 may be a leaky wave antenna. The specific structure of the leaky wave antenna may refer to related contents provided later, and is not described in detail herein.

As shown in FIG. 2, each transmitting antenna 10 may correspond to K radiation units 11 along the second direction, and K is an integer greater than 1, where each radiation unit 11 refers to a component capable of radiating a millimeter wave electromagnetic signal to free space. Each radiation unit 11 is configured to partially convert the electrical signal into a millimeter wave electromagnetic signal (the “partially” herein refers to the energy of the electrical signal). Moreover, there is a first phase difference between the millimeter wave electromagnetic signals emitted by any two adjacent radiation units 11. The first phase difference may change with the frequency of the electrical signal, so that the direction of the target beam may scan along the second plane. In some exemplary embodiments, when the transmitting antenna 10 is a leaky wave antenna, the transmitting antenna 10 may be sequentially provided with K slots along the second direction. When the transmitting antenna 10 is in operation, the partially leaked millimeter-wave electromagnetic signals of the K slots form the K radiation units.

In the following, an example will be given to illustrate the direction of the target beam scanning along the second plane with reference to FIG. 2. For ease of description in this description, the two transmitting antennas 10 shown in FIG. 2 are referred to as a first transmitting antenna and a second transmitting antenna in sequence from left to right. In addition, the K radiation units 11 of each transmitting antenna 10 are referred to as a first radiation unit, a second radiation unit . . . a Kth radiation unit.

Taking the second transmitting antenna 10 in FIG. 2 as an example, after this transmitting antenna 10 receives an electrical signal from the signal processing circuit 200, the radiation units 11 on it partially convert the electrical signal into millimeter wave electromagnetic signals (the “partially” herein refers to the energy of the electrical signal), and then radiate the millimeter wave electromagnetic signals to free space. With reference to FIG. 1, taking the K−1th radiation unit and the Kth radiation unit as examples, both the K−1th radiation unit and the Kth radiation unit radiate millimeter wave electromagnetic signals to free space. Moreover, there is a first phase difference between the millimeter wave electromagnetic signals emitted by these two radiation units. Therefore, the millimeter wave electromagnetic signals emitted by the K−1th radiation units and the Kth radiation unit interfere with each other in free space to form a beam, and the beam is directed to a direction along the second plane (yOz plane or a plane parallel to the yOz plane). When the frequency of the electrical signal received by the transmitting antenna 10 changes, the first phase difference between the millimeter wave electromagnetic signals emitted by the K−1th radiation unit and the Kth radiation unit also changes. In such a case, the millimeter wave electromagnetic signals emitted by the K−1th radiation unit and the Kth radiation unit interfere in free space to form a beam, and the direction of the beam varies along the second plane. As the frequency of the electrical signal received by the transmitting antenna 10 changes continuously, the beam formed by the radiations of the K−1th radiation unit and the Kth radiation unit may scan along the second plane within a preset angle range (e.g., α).

It should be noted that FIG. 2 only shows the case where the K−1th radiation unit and the Kth radiation unit of the second transmitting antenna emit millimeter wave electromagnetic signals to form a beam. It should be understood that the radiation of millimeter wave electromagnetic signals from other radiation units (the 1st radiation unit to the K−2th radiation unit) of the transmitting antenna is similar. In this way, the millimeter wave electromagnetic signals emitted by all the radiation units 11 of the transmitting antenna may interfere in free space to form a beam, and the beam is directed to scan along the second plane.

In some exemplary embodiments, the signal processing circuit 200 may control the direction of the target beam to scan along the third plane by adjusting the second phase differences between the N electrical signals. For example, the signal processing circuit 200 may adjust the phases of the N electrical signals so that the electrical signals received by any two adjacent transmitting antennas 10 in the antenna module 100 have the same second phase difference.

The case where the target beam is directed to scan along the third plane will be illustrated below with reference to FIG. 2. With reference to FIG. 2, when there is a second phase difference between the electrical signals received by two transmitting antennas 10, the millimeter wave electromagnetic signals emitted by the first radiation units of the two transmitting antennas 10 interfere in free space to form a beam. The beam may be directed along a certain direction on the third plane (xOy plane or a plane parallel to the xOy plane). When the second phase difference between the electrical signals received by the two transmitting antennas 10 changes, the millimeter wave electromagnetic signals emitted by the first radiation units of the two transmitting antennas 10 interfere in free space to form a beam, and the direction of the beam changes along the third plane. As the second phase difference between the electrical signals received by the two transmitting antennas 10 is constantly changing, the beam formed by the radiation of the first radiation units of the two transmitting antennas 10 may scan along the third plane within a preset angle range (e.g., θ).

It should be noted that FIG. 2 only shows the case where the first radiation units of the two transmitting antennas 10 emit millimeter wave electromagnetic signals to form a beam. It should be understood that the radiation of millimeter wave electromagnetic signals by other radiation units (the 2nd radiation unit to the Kth radiation unit) in the two transmitting antennas 10 is similar. In this way, the millimeter wave electromagnetic signals emitted by all the radiation units 11 of the two transmitting antennas 10 interfere in free space to form a beam, and the beam is directed to scan along the third plane. It can be seen that, by adjusting the second phase differences between the N electrical signals, the signal processing circuit 200 may make the target beam emitted by the antenna module 100 (a beam formed by the interference of the millimeter wave electromagnetic signals emitted by all the radiation units 11 of the N transmitting antennas) directed to scan along the third plane.

According to the present disclosure, by employing the transmitting antenna 10 that has the characteristic of beam scanning with frequency, the antenna module 100 only needs to arrange multiple transmitting antennas 10 along one direction (the first direction), without arranging them along other directions, in order to achieve two-dimensional scanning of the target beam. According to the actual test results, it is found that the spatial resolution and beam scanning range obtained by “arranging one transmitting antenna 10 along the first direction” may be equivalent to those effects achieved by “arranging dozens of traditional transmitting antennas along the second direction.” Therefore, the solution provided by the present disclosure may greatly reduce the number of transmitting antennas 10 in the antenna module 100 while achieving the same scanning effect. It can be seen that the solution of the present disclosure may realize the two-dimensional scanning of the target beam under the condition of providing a small number of transmitting antennas 10. It can be understood that when the number of transmitting antennas 10 arranged in the antenna module 100 is small, the number of channels for the transmitting antennas 10 may also be reduced. Therefore, the cost of the beam scanning system may be greatly reduced. It can be seen that the beam scanning system provided by the present disclosure may realize two-dimensional scanning of the target beam at a low cost.

As mentioned above, the transmitting antenna 10 in the present disclosure may be a leaky wave antenna, and the structure of the leaky wave antenna will be described below.

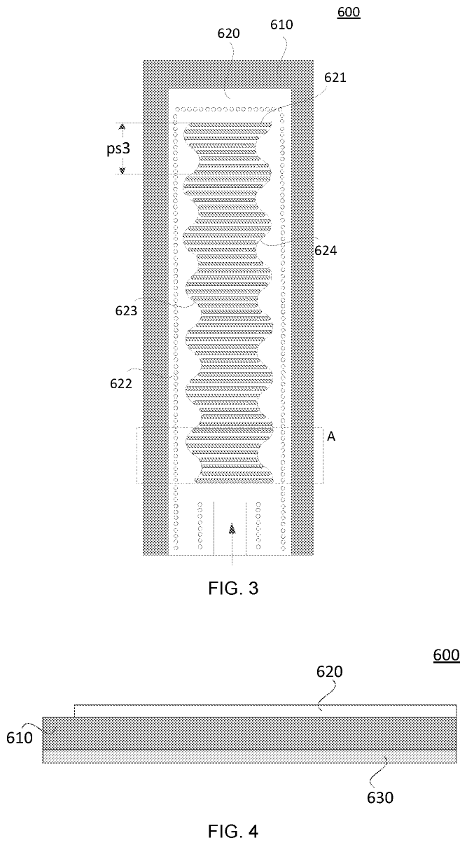

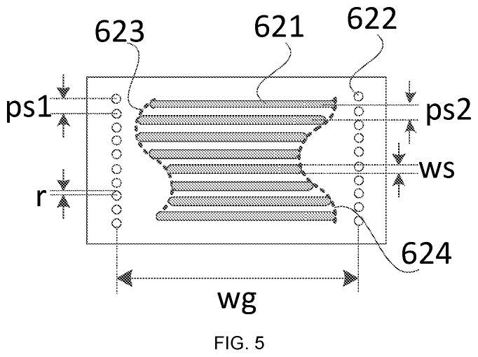

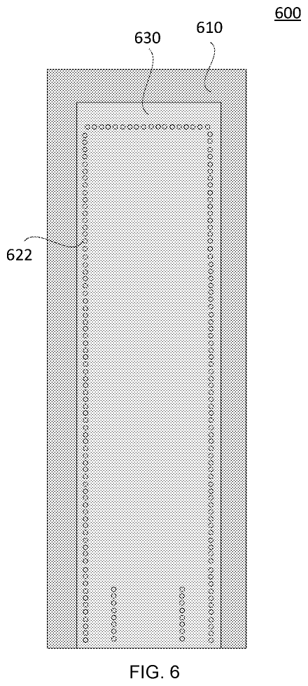

FIG. 3 is a front view of a leaky wave antenna provided according to some exemplary embodiments of the present disclosure. FIG. 4 is a side view of the leaky wave antenna shown in FIG. 3. FIG. 5 is an enlarged view of the part A shown in FIG. 3. FIG. 6 is a rear view of the leaky wave antenna shown in FIG. 3. A leaky wave antenna 600 may be used as the transmitting antenna 10 in the system 001 shown in FIG. 1 and FIG. 2.

As shown in FIG. 3, FIG. 4, FIG. 5 and FIG. 6, the leaky wave antenna 600 may include: a first metal sheet 620. In some exemplary embodiments, the leaky wave antenna 600 may further include a substrate 610 and a second metal sheet 630. The substrate 610 may include a first surface and a second surface arranged opposite to each other. The first metal sheet 620 may be disposed on the first surface of the substrate 610, and the second metal sheet 630 may be disposed on the second surface of the substrate 610. In some exemplary embodiments, both the first metal sheet 620 and the second metal sheet 630 may be made of copper foil. The first metal sheet 620 may be used as a radiation surface of the leaky wave antenna 600, and the second metal sheet 630 may be configured as a ground.

The leaky wave antenna 600 may adopt a substrate integrated waveguide (SIW) structure. In some exemplary embodiments, the substrate 610 may be a printed circuit board (PCB). For example, the substrate 610 may adopt Rogers RO 3003 printed circuit board, where thickness h=0.25 mm, relative permittivity εᵣ=3.0, and tangent of loss angle δ tanδ=0.001. Both the first metal sheet 620 and the second metal sheet 630 may be formed on two surfaces of the substrate 610 by a printing process.

In some exemplary embodiments, the leaky wave antenna 600 may further include a plurality of metallized through holes 622. The plurality of metallized through holes 622 may be periodically arranged along an edge(s) of the first metal sheet 620. Each metallized through hole 622 passes through the first metal sheet 620, the substrate 610 and the second metal sheet 630. The second metal sheet 630 is configured to be grounded, and the metallized through holes 622 penetrate the first metal sheet 620, the substrate 610 and the second metal sheet 630. As a result, the first metal sheet 620 and the second metal sheet 630 are electrically connected. In this way, the first metal sheet 620, the second metal sheet 630 and the plurality of metallized through holes 622 form a closed space similar to a metal waveguide. Therefore, a millimeter wave electromagnetic signal may be restricted to be transmitted along a second direction within the closed space. In some exemplary embodiments, as shown in FIGS. 3 to 6, a row of metallized through holes may be respectively provided on two edges of the first metal sheet 620 along a long axis direction thereof. The distance between two rows of metallized through holes 622 may be the effective waveguide width wg. Generally, the waveguide width wg is related to the working frequency band of the leaky wave antenna 600. For example, when the working frequency band of the leaky wave antenna 600 is 60 GHz to 64 GHz, the waveguide width wg may be 2.1 mm, or a value with a deviation from 2.1 mm within a preset range.

It should be noted that, the present disclosure does not limit the shape of the metallized through holes 622, for example, it may be circular, oval, square, or the like. In FIGS. 3 to 6, a circular metallized through hole is taken as an example for illustration. Moreover, the present disclosure does not limit the radius r of the metallized through hole 622 and the distance ps1 between adjacent metallized through holes. In some exemplary embodiments, the multiple metallized through holes 622 may be arranged densely. For example, the radius r of the metallized through holes 622 may be less than or equal to 0.3 mm, and the distance ps1 between the center points of two adjacent metallized through holes 622 may be less than or equal to 1 mm. In some exemplary embodiments, the radius r of the metallized through holes 622 may be 0.25 mm, and the distance ps1 between the center points of two adjacent metallized through holes 622 may be 0.44 mm. It should be understood that when the multiple metallized through holes 622 are arranged densely, it is equivalent to forming a “metal wall” on the side(s) of the waveguide. Therefore, millimeter wave electromagnetic signals may not leak through the side(s) of the waveguide, reducing energy loss.

In the application scenarios of the millimeter wave frequency band, the frequency of the millimeter wave electromagnetic signal is relatively high. Thus, adopting the traditional waveguide structure may make the volume of the waveguide too large, which is not easy to miniaturize and integrate. In the present disclosure, the leaky wave antenna 600 is prepared by adopting the technology of substrate integrated waveguide. On the one hand, it can reduce the volume of the waveguide and facilitate the miniaturization design of the antenna. On the other hand, energy is not easy to leak to the outside through the sides of the waveguide, thus does not interfere with external radiation sources; the anti-interference ability of the leaky wave antenna is also enhanced.

In some exemplary embodiments, as shown in FIG. 3, K slots 621 are sequentially arranged on the first metal sheet 620 along a second direction, where the second direction is the extending direction of the leaky wave antenna 600. The multiple metallized through holes 622 surround the K slots 621. When the leaky wave antenna 600 is in operation, the leaky wave antenna 600 receives an electrical signal(s) from the signal processing circuit 200 and at least partially converts the electrical signal(s) into a millimeter wave electromagnetic signal(s). The millimeter wave electromagnetic signal is conducted along the second direction in the leaky wave antenna 600. During the conduction of the millimeter wave electromagnetic signal, the K slots 621 partially leak the millimeter wave electromagnetic signal, so that the K slots 621 may form K radiation units.

When the leaky wave antenna 600 is in operation, the slots 621 form a capacitance in the propagation direction (i.e., the second direction) of the millimeter wave electromagnetic signal, which may hinder and stop the propagation of the millimeter wave electromagnetic signal (that is, the slow wave effect), thus slowing down the propagation speed of millimeter wave electromagnetic signal. It can be understood that the more and denser the slots 621, the more significant the slow wave effect. This makes the first phase difference between the millimeter wave electromagnetic signals leaked by two adjacent slots 621 more sensitive to a frequency change of the electrical signals. That is to say, the first phase difference between the millimeter wave electromagnetic signals leaked by two adjacent slots 621 changes more significantly even if the frequencies of the electrical signal change a little. This makes the direction of the beam also change significantly, so that the scanning rate of the leaky wave antenna may be improved.

In some exemplary embodiments, the slot 621 may have an elongated shape. For example, the width ws of the slot 621 may be smaller than a preset threshold. The preset threshold may depend on the antenna processing technology. That is to say, the width ws of the slot 621 may be as narrow as the processing technology allows. For example, the width ws of the slot 621 may be less than or equal to 0.3 mm. In some exemplary embodiments, the width ws of the slot 621 may be 0.1 mm. In addition, the distance ps2 between the central axes of any two adjacent slots 621 may also be smaller than a specified threshold. For example, the ps2 may be less than or equal to 1 mm. In some exemplary embodiments, ps2 may be 0.22 mm. It should be understood that when the width ws of the slot 621 is narrow and the distance ps2 between the central axes of two adjacent slots 621 is small, it would be convenient to provide more and denser slots 621 on the leaky wave antenna 600. Based on the foregoing description, when there are more and denser slots 621, the slow wave effect is more significant, so that the scanning rate of the leaky wave antenna may be improved.

In practical applications, the millimeter wave has a short wavelength and is easily affected by the absorption and scattering of gas molecules, hydrometeors, and suspended dust in the atmosphere, and thus the path loss is very serious. Therefore, in some exemplary embodiments, when the leaky wave antenna 600 is applied in the millimeter wave frequency band, the edge(s) of the slot 621 may be smooth edge(s). For example, the shape of the slot 621 may be a rounded rectangle. In this way, there will be no sharp corners at the edges of the slot 621. It should be understood that under normal circumstances, the impedance formed by a sharp corner is relatively high. As a result, when current flows near the sharp corner, the electric field will be enhanced, resulting in a large energy loss. Therefore, in the present disclosure, by designing the edge(s) of the slot 621 as a smooth edge(s), the energy loss of the leaky wave antenna 600 may be reduced as much as possible, and the radiation performance of the leaky wave antenna 600 in the millimeter wave frequency band may be improved.

It should be noted that the present disclosure does not limit the extending direction of the slots 621. In some exemplary embodiments, as shown in FIG. 3, the extending direction of the slots 621 may be the first direction. In such a case, the direction of the electric field formed by the slots 621 is perpendicular to the propagation direction (the second direction) of the millimeter wave electromagnetic signal. In some exemplary embodiments, the extending direction of the slots 621 may form a non-zero preset angle with the first direction. For example, the angle between the extending direction of the slots 621 and the first direction may be 45°. In such a case, the direction of the electric field formed by the slots 621 is no longer perpendicular to the propagation direction (the second direction) of the millimeter wave electromagnetic signal, so that the polarization direction of the leaky wave antenna 600 changes. Therefore, in practical applications, the extending direction of the slots 621 may be designed according to the requirements of the specific application scenario for the polarization direction.

In some exemplary embodiments, as shown in FIG. 3, the leaky wave antenna 600 may include a long axis extending in the second direction. There are a first reference line 623 and a second reference line 624 on two sides of the long axis of the leaky wave antenna 600. The first reference line 623 and the second reference line 624 are located inside the waveguide area surrounded by the multiple metal through holes 322. Two ends of each slot 621 are respectively located on the first reference line 623 and the second reference line 624. It should be noted that the first reference line 623 and the second reference line 624 are not actual physical lines on the leaky wave antenna 600, but should be understood as two virtual lines. In other words, the first reference line 623 is a virtual line obtained by fitting the first ends of the K slots 621, and the second reference line 624 is a virtual line obtained by fitting the second ends of the K slots 621.

The first reference line 623 and the second reference line 624 extend along the second direction respectively, but they are not straight lines. Since both the first reference line 623 and the second reference line 624 are not straight lines, the K slots 621 are misaligned along the first direction (for example, the ends of two adjacent slots 621 or several adjacent slots 621 are not aligned). In this way, the K slots 621 may radiate millimeter wave electromagnetic signals to free space.

In some exemplary embodiments, the first reference line 623 and the second reference line 624 may be polylines, for example, triangular-wave polylines, square-wave polylines, or any other types of polylines. In some exemplary embodiments, as shown in FIG. 3, both the first reference line 623 and the second reference line 624 may be smooth curves, such as sinusoidal curves, cosine curves, quasi-sinusoidal curves, quasi-cosine curves, or any other type of smooth curves. It can be understood that when the first reference line 623 and the second reference line 624 are smooth curves, there will be no sharp corners in the current flow area. This may reduce energy loss, so that the energy loss during the operation of the leaky wave antenna 600 may be less than a preset threshold. In practical applications, the millimeter wave has a short wavelength and is easily affected by the absorption and scattering of gas molecules, hydrometeors, and suspended dust in the atmosphere, and thus the path loss is very serious. Therefore, when the leaky wave antenna 600 is applied to the millimeter wave frequency band, the first reference line 623 and the second reference line 624 may be designed as smooth curves. This may reduce the energy loss in the medium propagation stage as much as possible, so that the leaky wave antenna 600 may have high radiation performance in the millimeter wave frequency band.

In some exemplary embodiments, both the first reference line 623 and the second reference line 624 may be periodic target curves or target polylines. For example, FIG. 3 exemplifies the situation in which both the first reference line 623 and the second reference line 624 adopt periodic sinusoidal curves. The period length ps3 of the target curve or the target polyline (that is, the length of each period of the target curve or the target polyline in the second direction) is related to the working frequency band of the leaky wave antenna 600. In general, the higher the working frequency band of the leaky wave antenna 600 is, the shorter the period length of the target curve or target polyline is. For example, when the working frequency band of the leaky wave antenna 600 is 60 GHz to 64 GHz, the period length ps3 of the target curve or the target polyline may be 1.76 mm, or the difference between ps3 and 1.76 mm is within a preset error range. The first reference line 623 and the second reference line 624 may adopt a periodic design, so that the millimeter wave electromagnetic signal may undergo multiple cycles of radiation during the conduction process, thereby increasing the energy radiation rate.

It should be understood that when the number of cycles of the target curve/target polyline of the first reference line 623 and the second reference line 624 is large, the energy radiation rate of the antenna is high. However, the length of the antenna is also relatively long, which is not conducive to the miniaturization design of the antenna. When the number of cycles of the target curve/target polyline of the first reference line 623 and the second reference line 624 is small, the length of the antenna is relatively short, which is conducive to the miniaturization design of the antenna. However, due to the low energy radiation rate, the remaining energy may be reflected at the end of the antenna, which may interfere with the energy radiation. Therefore, in practical applications, the antenna length may be designed based on a preset target energy radiation rate. For example, assuming the target curve/target polyline has x number of periods, the value of x may be increased to test the energy radiation rate of the antenna. When the measured energy radiation rate is greater than or equal to the preset target energy radiation rate, the antenna length may be determined based on the current value of x. For example, the preset target energy radiation rate may be 90%. It should be noted that FIG. 3 only uses the number of cycles x=7 as an example for illustration. The present disclosure does not limit the specific value of x.

In some exemplary embodiments, as shown in FIG. 3, the first reference line 623 and the second reference line 624 may be asymmetrical along the long axis of the leaky wave antenna 600. The long axis herein may refer to the central axis of the leaky wave antenna 600 along the second direction, or may be other axes parallel to the central axis. For example, in FIG. 3, the first reference line 623 and the second reference line 624 are both sinusoidal curves. There is a certain misalignment between the two in the direction of the long axis (that is, there is a preset phase difference between the two in the direction of the long axis), so that the two are asymmetrical along the long axis. In some exemplary embodiments, the preset phase difference enables the leaky wave antenna to continuously scan in a direction with a side-fire angle of 0°.

In practical applications, when the first reference line 623 and the second reference line 624 adopt a periodic design, the beam radiated by the leaky wave antenna 600 may produce a side-fire stop band effect. That is, there is a scanning dead zone in the direction where the side-fire angle is 0°, so that the side-fire scanning range of the beam is not continuous. In the present disclosure, the first reference line 623 and the second reference line 624 may be designed asymmetrically. This may eliminate the side-fire stop band effect, so that the beam may also scan in the direction where the side-fire angle is 0°. In this way, the side-fire scanning range of the beam may be continuous, and the side-fire scanning range of the beam may be expanded.

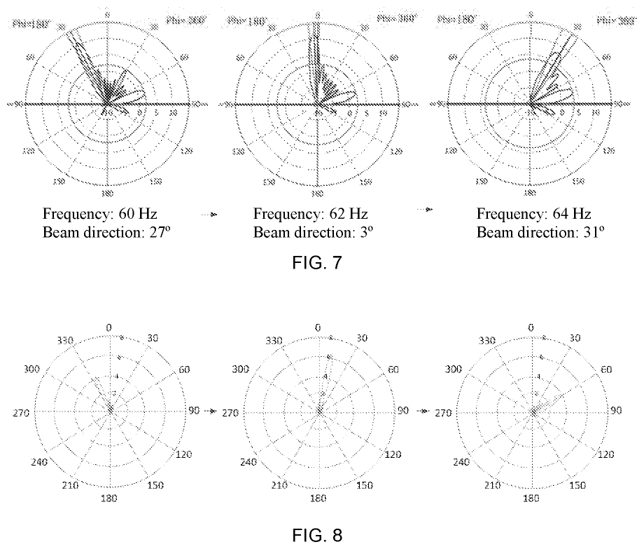

The scanning results of the two-dimensional scanning of the target beam by using the leaky wave antenna will be described below with reference to FIG. 7 and FIG. 8. FIG. 7 is a radiation pattern of the beam scanning system on a yOz plane according to some exemplary embodiments of the present disclosure; and FIG. 8 is a radiation pattern of the beam scanning system on a xOz plane according to some exemplary embodiments of the present disclosure. The beam scanning system includes an antenna module and a signal processing circuit. The antenna module adopts three leaky wave antennas 600 arranged sequentially along the x-axis direction on the xOz plane. The extension direction of each leaky wave antenna 600 is the z-axis direction. The structure of each leaky wave antenna 600 is as shown in FIGS. 3 to 6, and the parameters of the leaky wave antenna 600 are as follows:
The number of cycles of the sinusoidal curve x=20;
The period length of the sinusoidal curve ps3=1.76 mm;
The width of the gap ws=0.1 mm;
The distance between the central axes of two adjacent slots ps2=0.22 mm;
The radius of the metallized through hole r=0.25 mm;
The distance between the center points of two adjacent metallized through
holes ps1=0.44 mm; and
The effective waveguide width wg=2.1 mm.

The working frequency band of the leaky wave antenna 600 is 60 GHz to 64 GHz. The signal processing circuit provides one electrical signal to each of the three leaky wave antennas 600 respectively. The frequencies of the three electrical signals are adjusted to continuously change within the above working frequency range, and the phase differences between the three electrical signals are also adjusted. During the test, the direction of the target beam radiated by the antenna module is collected, and the radiation patterns are shown in FIG. 7 and FIG. 8.

See FIG. 7, on the yOz plane, when the frequency of the electrical signal input by the signal processing circuit to the leaky wave antenna 600 is 60 GHz, the direction of the target beam is 27° (phi=180°); when the frequency of the electrical signal input by the signal processing circuit to the leaky wave antenna 600 is 62 GHz, the direction of the target beam is 3° (phi=180°); and when the frequency of the electrical signal input by the signal processing circuit to the leaky wave antenna 600 is 64 GHz, the direction of the target beam is 3° (phi=360°). It can be seen that as the frequency of the electrical signal changes continuously within the above-mentioned working frequency band, the scanning range of the target beam on the yOz plane can reach 58°. With reference to FIG. 8, on the xOy plane, the signal processing circuit may adjust the phase differences between the three electrical signals so that the scanning range of the target beam on the xOy plane can reach 90°.

In summary, the beam scanning system provided by the present disclosure includes an antenna module and a signal processing circuit, where the antenna module includes N transmitting antennas arranged along a first direction on a first plane, and N is an integer greater than 1. Each transmitting antenna extends along a second direction on the first plane and is configured to convert an electrical signal into a millimeter wave electromagnetic signal. N millimeter wave electromagnetic signals sent by the N transmitting antennas may form a target beam. The signal processing circuit is connected with the antenna module. In operation, the target beam is controlled to perform two-dimensional scanning by outputting a frequency and phase controllable electrical signal for each of the N transmitting antennas respectively. Thus, it may be seen that the solutions of the present disclosure may adjust the frequency and phase of the electrical signal output to each of the N transmitting antennas via the signal processing circuit in the case where the multiple transmitting antennas in the antenna module are arranged only along one direction (the first direction), such that two-dimensional scanning of the target beam may be achieved. Compared with related technologies that require multiple transmitting antennas to be arranged in multiple directions, the present disclosure reduces the number of transmitting antennas in the antenna module. Correspondingly, the number of channels working with the transmitting antennas may also be reduced, thereby reducing the cost. That is to say, the beam scanning system provided by the present disclosure may achieve the two-dimensional scanning of the target beam at a low cost.

The foregoing describes some specific exemplary embodiments of the present disclosure. Other embodiments also fall within the scope of the appended claims. In some cases, the actions or steps described in the claims may be performed in sequences different from those in the exemplary embodiments, and may still achieve expected results. In addition, the processes depicted in the accompanying drawings do not necessarily require the specific orders or sequences as shown in order to achieve the expected results. In some implementations, multitasking and parallel processing may also be possible or may be advantageous.

In summary, after reading this detailed disclosure, those skilled in the art may understand that the foregoing detailed disclosure may be presented by way of example only, and may not be limited. Although there may be no explicit description, those skilled in the art may understand that this disclosure intends to cover various reasonable changes, improvements and modifications of the exemplary embodiments. These changes, improvements and modifications are intended to be included in this disclosure and are within the spirit and scope of this disclosure.

In addition, some specific terms in this disclosure have been used to describe the embodiments of this disclosure. For example, “one embodiment”, “an embodiment” and/or “some exemplary embodiments” mean that a specific feature, structure, or characteristic described in combination with the embodiment may be included in at least one embodiment of this disclosure. Therefore, it can be emphasized and should be understood that two or more references to “an embodiment” or “one embodiment” or “an alternative embodiment” in various parts of this disclosure do not necessarily all refer to the same embodiment. In addition, specific feature, structure, or characteristic may be appropriately combined in one or more embodiments of this disclosure.

It should be understood that in the foregoing description of the exemplary embodiments of this disclosure, to help understand a feature and for the purpose of simplifying this disclosure, this disclosure sometimes combines various features in a single embodiment, a drawing, or description thereof. However, this does not mean that the combination of these features is necessary. It is possible for those skilled in the art to extract some of the devices as a single embodiment when reading this disclosure. In other words, the embodiments in this disclosure may also be understood as an integration of multiple sub-embodiments. The content of each sub-embodiment may also be valid when it gas fewer features than a previously disclosed single embodiment.

Each patent, patent application, patent application publication and other materials cited herein, such as articles, books, disclosures, publications, documents, articles and the like, may be incorporated herein by reference. The entire content used for all purposes, except for any related litigation document history, any identical litigation document that may be inconsistent or conflicting with this document, or any identical litigation document that may have restrictive influence on the broadest scope of the claims' history, are associated with this document now or in the future. For example, if the description, definition, and/or use of terms in any associated materials contained herein is inconsistent with or in conflict with that in this document, the terms in this document shall prevail.

Finally, it should be understood that the exemplary embodiments of the present disclosure disclosed herein are for describing the principle of the embodiment of this disclosure. Other modified embodiments are also within the scope of this disclosure. Therefore, the embodiments disclosed in this disclosure are merely examples rather than limitations. Those skilled in the art may adopt alternative configurations according to the exemplary embodiments of this disclosure to implement the application in this disclosure. Therefore, the embodiments of this disclosure are not limited to those explicitly described in the present disclosure.

What is claimed is:

1. A beam scanning system, comprising:
an antenna module, including N transmitting antennas arranged in a first direction on a first plane, wherein N is an integer greater than 1, each of the N transmit antennas extends in a second direction on the first plane and is configured to convert an electrical signal into a millimeter wave electromagnetic signal, and N millimeter wave electromagnetic signals sent by the N transmitting antennas form a target beam; and
a signal processing circuit connected with the antenna module, wherein during operation, the signal processing circuit controls the target beam to perform two-dimensional scanning by outputting one electrical signal with controllable frequency and phase to each of the N transmitting antennas respectively.

2. The system according to claim 1, wherein, to control the target beam to perform the two-dimensional scanning, the signal processing circuit is configured to control the target beam to scan on a second plane by adjusting frequencies of the N electrical signals to change within a preset frequency band.

3. The system according to claim 2, wherein the second plane is perpendicular to the first plane, and parallel to the second direction.

4. The system according to claim 2, wherein
each of the N transmitting antennas includes K radiation units in the second direction, wherein K is an integer greater than 1;
each of the K radiation units partially converts part of the electrical signal into the millimeter wave electromagnetic signal, wherein
there is a first phase difference between millimeter wave electromagnetic signals emitted by any two adjacent radiation units, and
the first phase difference changes with the frequencies of the electrical signals to allow the target beam to scan on the second plane.

5. The system according to claim 4, wherein
each of the N transmit antennas includes a long axis extending in the second direction;
a first reference line and a second reference line extending in the second direction are respectively located on two sides of the long axis;
neither the first reference line nor the second reference line is a straight line; and
two ends of each radiation unit are respectively located on the first reference line and the second reference line.

6. The system according to claim 5, wherein the first reference line and the second reference line are smooth curves, so that energy loss of the N transmitting antennas during operation is less than a preset threshold.

7. The system according to claim 5, wherein both the first reference line and the second reference line are periodic target curves or target polylines.

8. The system according to claim 5, wherein the first reference line and the second reference line are asymmetric with respect to the long axis.

9. The system according to claim 2, wherein
each of the N transmitting antennas includes a first metal sheet;
the first metal sheet includes K slots sequentially arranged in the second direction; and
during operation, the K slots partially leak the millimeter wave electromagnetic signal to form the K radiation units.

10. The system according to claim 9, wherein edges of each slot are smooth edges.

11. The system according to claim 9, wherein each of the N transmitting antennas further includes:
a substrate, including a first surface and a second surface disposed opposite to each other, wherein the first metal sheet is disposed on the first surface;\
a second metal sheet, disposed on the second surface and configured to be grounded; and
a plurality of metallized through holes, wherein each of the plurality of metallized through holes passes through the first metal sheet, the substrate and the second metal sheet, and the plurality of metallized through holes surround the K slots.

12. The system according to claim 1, wherein, to control the target beam to perform the two-dimensional scanning, the signal processing circuit controls the target beam to scan on a third plane by adjusting second phase differences between 2 adjacent electrical signals of the N electrical signals.

13. The system according to claim 12, wherein the third plane is perpendicular to the first plane and parallel to the first direction.

14. The system according to claim 1, wherein a working wavelength of the antenna module is λ, a distance between any two adjacent transmitting antennas in the antenna module is d1, and a difference between d1 and λ/2 is within a preset range.

15. The system according to claim 1, wherein a working frequency band of the antenna module includes 60 GHz to 64 GHz.
